(19) United States
(12) Patent Application Publication
(10) Pub. No.: US 2013/0229579 A1
(43) Pub. Date: Sep. 5, 2013

(54) HDMI DEVICE SHOWING NETWORK MAP AND DEVICE ADDRESSES

(71) Applicant: Libiao Jiang, San Diego, CA (US)

(72) Inventor: Libiao Jiang, San Diego, CA (US)

(73) Assignee: SONY CORPORATION

(21) Appl. No.: 13/409,406

(22) Filed: Mar. 1, 2012

(51) Int. Cl. H04N 5/50; H04N 5/445

(52) U.S. Cl. 348/569; 348/E05.097; 348/E05.099; 348/E05.102

(57) ABSTRACT

A graphic representation of a home AV system is shown on a video display in the system depicting CEC device hierarchy, if desired according to their physical addresses. Devices that failed to obtain physical addresses also can be depicted so indicating, and HDMI physical addresses and device types of each device may also be indicated. Furthermore, the path currently in use from an active source to the active sink is shown, as are alternate AV paths. At the initial setup or when new devices are to join the network, the graphic representation can be automatically presented, if desired with help text on screen to guide the user. A debug/information button is provided to the user in the case the devices are not functioning correctly.

### I. FIELD OF THE INVENTION

The present application relates generally to high definition multimedia interface (HDMI) device displays of network maps pertaining to the HDMI devices.

### II. BACKGROUND OF THE INVENTION

Present principles recognize that the Consumer Electronics Control (CEC) protocol of high definition multimedia interface (HDMI) allows various audio video (AV) devices to communicate and interoperate in a somewhat seamless manner, reducing the number of remotes/number of button pressing needed for typical AV devices use. For example, without CEC, to play a digital video disk the user must usually turn on the disk player, put in the disk, turn on the TV, switch TV's input to “disk player”, press the PLAY button on the player, turn on the AV receiver, and switch the AV receiver's input to “disk player”. With CEC, this somewhat cumbersome procedure reduces to energizing the disk player, put in the disk, and press the PLAY button.

By way of precision, the terms Physical Address and Logical Address as used herein are defined by Section 8.7 of HDMI standards, and Section 10.2 of “Supplement 1 Consumer Electronics Control (CEC)”, respectively. For example, in more detail, for Physical address, the root device (usually a TV), has physical address 0.0.0.0 and logical address 0. A Blu-ray player connected to TV may have physical address 1 and logical address 4.

Furthermore, the term “actual connection” or its synonym, “HDMI physical port number”, may be used to describe user-identifiable connections. For example, an “actual connection” between a Blu-ray player and a TV means that the Blu-ray player is connected to, e.g., a visually identifiable label “HDMI port1” of the TV. Under ideal situations, all devices on the HDMI-CEC network would have correct physical addresses. However, sometimes discrepancies between a physical address and a corresponding actual connection occur. For example, the user knows that his Blu-ray player is directly connected to his TV, therefore the physical address of the Blu-ray player should be n.0.0.0, where 1≦n≦m, where m is the maximum number of HDMI ports of the TV. However for some reason the Blu-ray player may “think” that it has a physical address of 1.n.0.0, which means that the Blu-ray player thinks that it is connected to TV through another device in the middle. As further understood herein, it can be difficult for the user to setup/track which devices are connected to which ports especially when devices from other manufacturers are involved, due the various timing/order/special operations demanded by different manufacturers. For example, the physical port label-to-HDMI physical address correspondence used by one manufacturer may be different than that used by another manufacturer. This sometimes leads to unexpected/very frustrating user experiences such as devices turning on and off unexpectedly when the power button of the remote control (RC) is selected, or the TV switching input/channels unexpectedly, or always skipping a particular device making it impossible to play content from that device.

### SUMMARY OF THE INVENTION

It is to be understood that while a TV is used as an example device that implements present principles, the logic and on-screen graphics can be implemented on other types of devices within a HDMI-CEC network.

Accordingly, a system includes a TV display, a TV processor controlling the display, and computer readable memory accessible to the processor and bearing instructions executable by the processor to present a network map on the display. The map shows respective icons representing the TV and plural components connected thereto. Also, the map shows a currently active audio video (AV) path from a component to the TV and a currently inactive AV path from a component to the TV, and the active video path appears differently than the inactive video path. The map also shows a selector element selectable to cause an address of an input port, or a component, or both an input port and a component to be presented on the display.

In example embodiments, the icons may bear labels indicating what type of component they respectively represent. The currently active AV path can be highlighted relative to the currently inactive AV path. In non-limiting examples, an icon representing a source of AV has a first shape and an icon representing a player of AV has a second shape, and the first shape is different from the second shape. Indeed, all icons representing sources of AV may have the first shape and all icons representing players of AV may have the second shape.

As set forth further below, in example implementations, responsive to selection of the selector element, physical port numbers of input ports to which connections have been made are shown on the display. Yet again, responsive to selection of the selector element, HDMI physical addresses based on connected input ports may be shown on the display.

If desired, the selector element can be a first selector element and the map can include a second selector element selectable to present an onscreen display (OSD) on the TV display giving a viewer an option to refresh the map. The OSD may give a viewer an option to remove an icon from the map. Also, the OSD can include a selectable entry allowing a user to define multiple functions for a single key on a remote control (RC).

In another aspect, a method includes presenting a graphic representation of a home audio video (AV) system on a video display depicting consumer electronics control (CEC) device hierarchy in the AV system, and indicating, on the video display along with the graphical representation, logical addresses and device types of each CEC device.

In another aspect, a TV includes a TV display, a TV processor controlling the display, and computer readable memory accessible to the processor and bearing instructions executable by the processor to present a network map on the display. The map shows respective icons representing the TV and plural components connected thereto. Also, the map can show a selector element selectable to cause at least one address of at least one input port or at least one component or at least one input port and at least one component to be presented on the display. Responsive to a first selection of the selector element, logical addresses based on connected input ports are shown on the display. In contrast, responsive to a second selection of the selector element, the logical addresses are removed from the display.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example TV in an example network;

FIG. 2 is an example screen shot of a network map showing the devices in the network of FIG. 1 along with various feature selector elements;

FIG. 3 is a screen shot as shown in FIG. 2 with the “show port number” selection made;

FIG. 4 is a screen shot as shown in FIG. 2 with the “show all addresses” selection made; and

FIG. 5 is a screen shot showing an example onscreen display presented in response to selection of the modify/debug selector element from FIG. 2.

### DETAILED DESCRIPTION OF THE PREFERRED EMBODIMENT

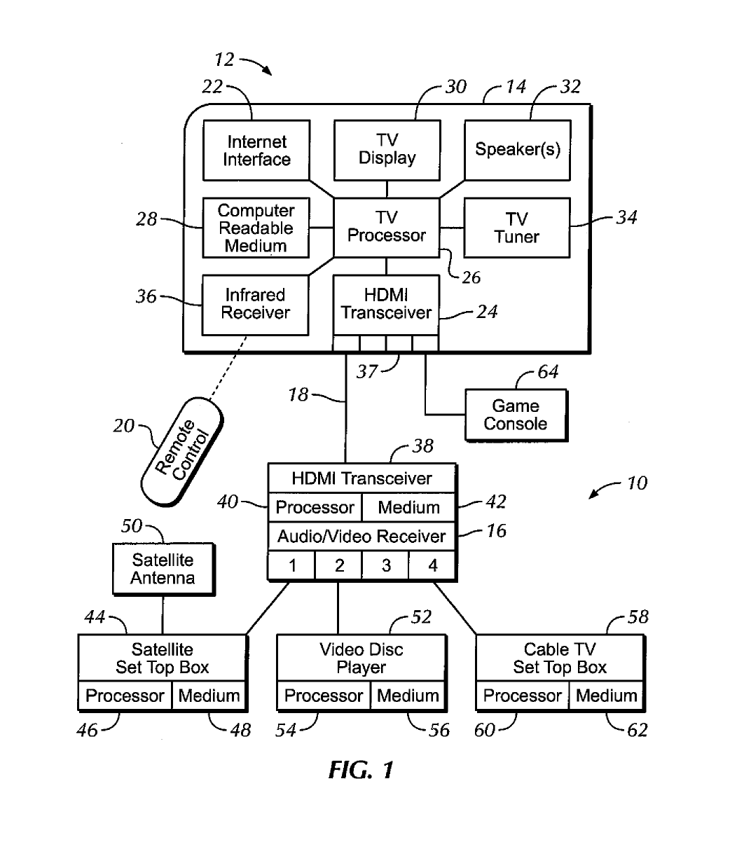

Referring initially to FIG. 1, a system is shown, generally designated 10, which includes a TV 12 having a TV chassis 14. While a TV 12 is depicted it is to be understood that present principles apply to audio-video display devices in general that that have a sufficiently good display screen and that support CEC.

As shown in FIG. 1, signals from an AV receiver 16 can be sent, typically via a wired or wireless high definition multimedia interface (HDMI) link 18, to the TV 12 for display thereof. The TV 12 and AV receiver 16 may be controlled by one or more remote commanders (RC) 20. The TV 12 may also communicate with the Internet through an Internet interface 22 such as a wired or wireless modem.

FIG. 1 shows that TV signals on the HDMI link 18 are received at the TV 12 by a HDMI receiver or transceiver 24 for provisioning to a TV digital processor 26 accessing computer readable storage media 28 such as disk or solid state storage to execute relevant logic set forth herein. The TV signals are output to a TV display 30 and audio speakers 32 controlled by the TV processor 26. Note that while FIG. 1 shows that the TV signals are provided to the processor 26 from the HDMI receiver 24, in actual implementation the signals may be routed to a TV tuner 34 controlled by the processor 26 and thence through display drivers to the TV display 30. User commands from a RC can be received by the TV processor 26 through a command signal receiver 36 such as an infrared (IR) receiver.

In the example embodiment shown in FIG. 1, the TV 12 includes four physical input ports 37. Assume the ports are numbered 1-4 from left to right. It will readily be appreciated form FIG. 1 that in the example shown, the AV receiver 16 is connected to input port “1” of the TV 12.

Turning to the AV receiver 16, this component may also include a HDMI transceiver 38 communicating with the TV 12 over the HDMI link 18. The receiver 16 includes a processor 40 accessing a computer readable storage medium 42 to transfer AV data between the TV 12 and various AV source devices described further below. In he example shown, the AV receiver 16 includes four input ports numbered 1-4 from left to right as shown.

Connected to receiver port “1” is a satellite integrated receiver/decoders (IRD) 44, also referred to herein for familiarity as a satellite “set top box” (STB). Among other components the satellite STB 44 includes a processor 46 accessing a computer readable storage medium 48 to send AV data from a satellite disk or antenna 50 to the AV receiver 16.

On the other hand, in the non-limiting example shown a video disk player 52 such as but not limited to a Blu-Ray disk player is connected to receiver port “2” of the AV receiver 16. Among other components the disk player includes a processor 54 accessing a computer readable storage medium 56 to send AV data from a removable video disk to the AV receiver 16.

Still further, in the non-limiting example shown a cable STB 58 is connected to receiver port “4” of the AV receiver 16. Among other components the STB 58 includes a processor 60 accessing a computer readable storage medium 62 to send AV data from a cable head end to the AV receiver 16. In the example shown, receiver port “3” of the AV receiver 16 has nothing connected to it.

Similarly, input ports “2” and “3” of the TV 12 have no components connected to them, but to illustrate that an AV component may be connected directly to the TV 12 if desired without going through the AV receiver 16, FIG. 1 shows that a computer game console 64 is connected directly to input port “4” of the TV 12.

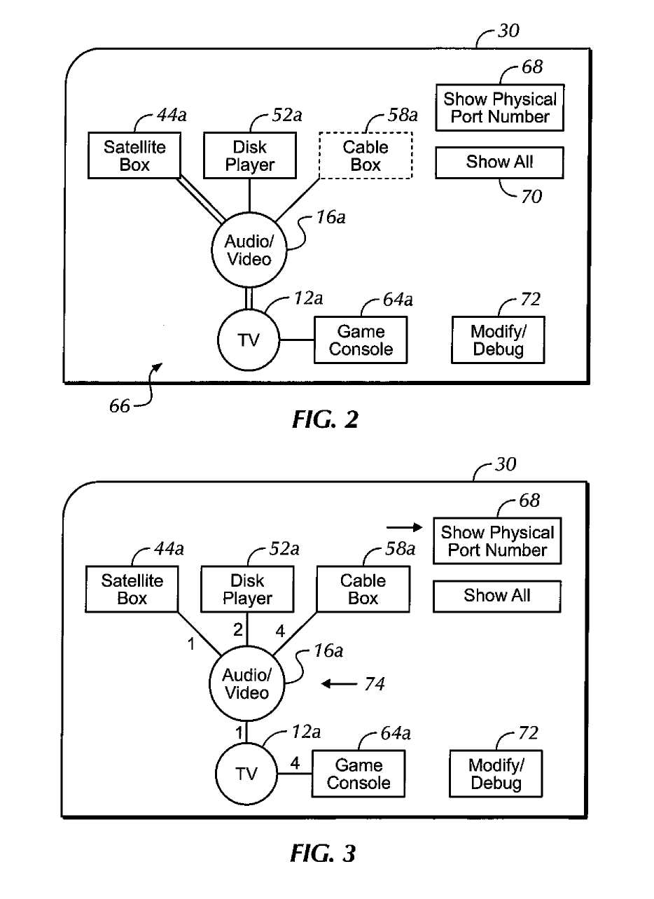

FIG. 2 shows an onscreen display (OSD) 66 that may be presented automatically on the video display 30 of the TV 12 upon power on, or upon a component being added or removed from the network, or responsive to a viewer manually commanding the TV to present the OSD 66 from, e.g., a setup menu on, for instance, a cross-media bar (XMB). As shown in FIG. 1, the OSD 66 depicts a map of the network shown in FIG. 1, i.e., a map of the user's home network. The map shows icons corresponding to the components in FIG. 1 as well as communication path lines between the components, so that a viewer can easily ascertain the hierarchy and topography of the network. Thus, the map shows a TV icon 12a connected to an AV receiver icon 16a. Note that the icons can bear labels indicating what type of device they represent. The map shows icons 44a, 52a, 58a connected via respective lines to the AV receiver icon 16a respectively representing the satellite STB 44, disk player 52, and cable STB 58. An icon 64 labeled as a game console and representing the console 64 is shown connected directly to the TV icon 12a.

The reader will note at this point that a currently used path, in this case, the path from the satellite STB icon 44a through the AV receiver icon 16a to the TV icon 12a, is highlighted, depicted in FIG. 2 by double lines, relative to the other (single) line paths, it being understood that the brightness or contrast of the current path may be increased or a different color used relative to the inactive, potentially useful lines. This indicates that the current TV input is from the satellite STB through the AV receiver.

The reader will further note that the cable STB icon 58a is grayed out as indicated by dashed lines. This is because, as an example, while the STB 58 may have been previously registered with the system, upon the most recent map refresh its presence was not detected. Note further that shapes of the icons can vary to indicate that they are receiving devices or source devices. Thus, the AV receiver icon 16a and TV icon 12a are round, whereas the icons for the source devices are square. Different colors may also or alternatively be used, e.g., receiver device icons may be green and AV source icons may be red.

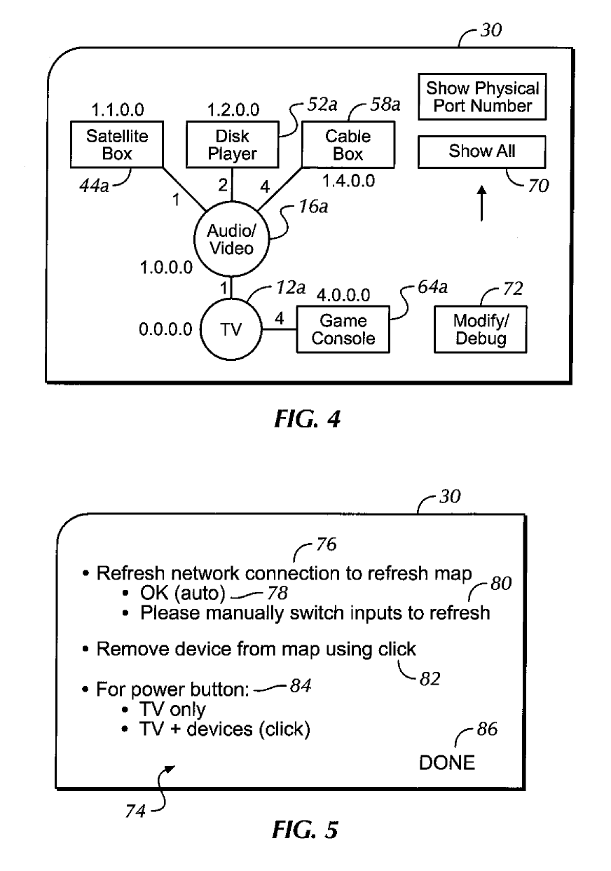

As shown in FIG. 2, a “show port number” selector element 68, “show all addresses” selector element 70, and “modify/debug” selector element 72 may be presented on the OSD 66. Responsive to user selection of the “show port number” selector element 68 using, e.g., the RC 20, the OSD of FIG. 3 is presented, whereas responsive to selection of the “show all addresses” selector element 70, the OSD of FIG. 4 is presented. FIG. 5 is presented responsive to selection of the “modify/debug” selector element 72.

As shown in FIG. 3, the physical port number to which each communication line entering a receiving device is connected is shown, preferably nearer the receiving device than the source device. Thus, and recalling the AV receiver ports to which the satellite STB 44, disk player 52, and cable STB 58 were connected, FIG. 3 shows a numeral “1” next to the line from the satellite STB icon 44a, a numeral “2” next to the line from the disk player icon 52a, and a numeral “4” next to the line from the cable box icon 58a. Recalling that the AV device 16 in turn is connected to physical port “1” of the TV 12, a numeral “1” is shown between the AV receiver icon 16a and the TV icon 12a. Also, recall that the game console 64 is connected to TV port “4” in FIG. 1. Consequently, a numeral “4” is shown between the game console icon 64a and the TV icon 12a. Thus, the physical ports to which the various components in FIG. 1 are connected are reflected in the display shown in FIG. 3. Note that if desired, for rigor the label could indicate that the physical ports are HDMI ports, so that the ports could be labeled “HDMI 1” as opposed to simply “1”.

FIG. 4, on the other hand, shows both physical ports and HDMI physical addresses, it being understood that the “a.b.c.d” format shown in FIG. 4 is sometimes referred to as HDMI physical addresses. It is to be understood that while the choices shown enable the user to present only physical ports or both physical port numbers and HDMI physical addresses, in other embodiments a selector element may be provided enabling presentation of HDMI physical addresses only.

In any case, as shown in the example of FIG. 4 the physical port numbers shown and described in relation to FIG. 3 are presented on the display 30, along with their corresponding HDMI physical addresses. Additionally, since the TV itself has an HDMI physical address, its address is shown next to the TV icon 12a and is 0.0.0.0. Since by HDMI specification, the TV physical port “1” usually tells the device to which it connects to take physical address 1.0.0.0, the address shown by the AV receiver icon 16a is 1.0.0.0. The HDMI physical address of the game console (connected to TV physical port 4) is 4.0.0.0 as shown.

On the other hand, the addresses of the components connected to the AV receiver 16 all begin with “1” to reflect the fact that the AV receiver 16 is connected to TV port 1, with the second numeral representing the physical port of the AV receiver 16 to which the component is connected. Thus, the address of the satellite STB 44, connected to AV receiver port 1, is 1.1.0.0, while the address of the disk player 52, connected to AV receiver physical port 2, is 1.2.0.0. The address of the cable STB 58 connected to physical port 4 of the AV receiver is 1.4.0.0. It is to be appreciated that in the event that a device is connected to an input port of one of the components connected to the AV receiver 16, the first two numerals of its address would be the same as the component that is connected to the AV receiver 16, while the third numeral would be the physical port number of the input port of the component to which the device is connected.

In any case, it may now be appreciated that not only do the maps shown in FIGS. 2-4 graphically show the network depicted in FIG. 1 including its hierarchy and levels, but also, if desired by the viewer, the various physical and/or logical network addresses involved. Toggling either selector element 68 or 70 as the case may be removes the addresses from view to de-clutter the OSD as desired by the viewer.

FIG. 5 shows an example OSD 74 that may be presented on the TV display 30 responsive to the selector element 72 being selected. As shown at 76 the viewer may be given the option to refresh the map shown in FIGS. 2-4. As shown at 80 the user may click on “auto” to cause the TV processor to automatically refresh the map using CEC query/registration procedures. In case a particular component requires a manual action such as switching inputs or re-plugging in the connector line in order to refresh the map, the user is so prompted at 80.

Examples of situations where user needs to use element 72 are: 1) the network map itself is not consistent, for example, two or more devices are showing the same physical address. 2) the network map is not consistent with actual connection, for example, a device connected to port 1 of TV is not showing physical address 1.0.0.0, or a connected device is not showing on the map at all. In case one, some visual cue (for example, an exclamation mark next to each offending device's icon) can be presented on the UI to prompt user about the potential problem and advise the use of element 72. In the case that a problem still exists after element 72 is selected by user, possible explanation/advice for further debugging can be present to user. For example, in the case a connected device not showing in the map, the possible explanation could be: A) that device does not support HDMI-CEC; B) that device's HDMI-CEC function has not been turned on; C) that device is beyond the 5^{th} layer of the HDMI-CEC network; D) all the logical addresses suitable for that device have been taken by other devices, thus that device cannot join the HDMI-CEC network.

Recall the above postulate that the cable STB 58 may have been previously registered with the network but may have become undetected for some reason, e.g., either removal of the STB or communication connection failure. The grayed out icon 58a signals this to the user. In case the user deliberately removed the STB 58, at 82 in FIG. 5 the user can select to remove the icon 58a from the map using a single click. If 82 is selected the map of FIGS. 2-4 reappears and the user need only click on the icon to be removed to remove it from the map. Thus, icon removal entails accessing the OSD 74 of FIG. 5, clicking on selection 82, then automatically presented the map and receiving a user click of an icon to be removed.

Entry 84 indicates but one non-limiting example for allowing a user to define multiple functions for the RC 20, in this, for the power button of the RC 20. As shown, the non-limiting example options include energizing the TV only responsive to manipulation of the power button, or energizing the TV plus one or more other components responsive to manipulation of the power button. Should the latter option be selected, the map is again presented and the user simply clicks the icon representing each component the user wishes to energize along with the TV. At the reception of each click a prompt can be presented on the map informing the user that the corresponding component will be energized when the power button is pressed, and asking if the user is done. If the user proceeds to click on additional icons, the user is informed that the corresponding components will be added to those energized when the power button is pressed. When the user indicates “done” the use case is complete and the OSD 74 of FIG. 5 or the above-described map reappears. All OSDs herein may be exited and normal video resumed from the currently active input source by pressing a “DONE” selector 86 shown in FIG. 5 only for brevity.

While the particular TV SHOWING NETWORK MAP AND DEVICE ADDRESSES is herein shown and described in detail, it is to be understood that the subject matter which is encompassed by the present invention is limited only by the claims.

What is claimed is:

1. System comprising:
display apparatus;
processor controlling the display apparatus; and
computer readable memory accessible to the processor and bearing instructions executable by the processor to present a network map on the display apparatus, the map showing respective icons representing the display apparatus and plural components connected thereto, the map showing a currently active audio video (AV) path from a component to the display apparatus, the map showing a currently inactive AV path from a component to the display apparatus, the active video path appearing differently than the inactive video path, the map also showing at least one selector element selectable to cause at least one address of at least one input port or at least one component or at least one input port and at least one component to be presented on the display apparatus.

2. The system of claim 1, wherein the icons bear labels indicating what type of component they respectively represent.

3. The system of claim 1, wherein the currently active AV path is highlighted relative to the currently inactive AV path.

4. The system of claim 1, wherein an icon representing a source of AV has a first shape and an icon representing a player of AV has a second shape, and the first shape is different from the second shape.

5. The system of claim 4, wherein all icons representing sources of AV have the first shape and all icons representing players of AV have the second shape.

6. The system of claim 1, wherein responsive to selection of the selector element, physical input port numbers to which connections have been made are shown on the display.

7. The system of claim 1, wherein responsive to selection of the selector element, HDMI physical addresses based on connected input ports are shown on the display.

8. The system of claim 1, wherein the selector element is a first selector element and the map includes a second selector element selectable to present an onscreen display (OSD) on the display giving a viewer an option to refresh the map.

9. The system of claim 8, wherein the OSD gives a viewer an option to remove an icon from the map.

10. The system of claim 8, wherein the OSD includes a selectable entry allowing a user to define multiple functions for a single key on a remote control (RC).

11. Method comprising:
presenting a graphic representation of a home audio video (AV) system on a video display depicting consumer electronics control (CEC) device hierarchy in the AV system; and
indicating on the video display along with the graphical representation HDMI physical addresses and device types of each CEC device.

12. The method of claim 11, comprising depicting the CEC devices on the graphical representation according to their respective physical addresses.

13. The method of claim 12, wherein CEC devices in the system that fail to obtain physical addresses in the system are visibly indicated as so failing to obtain physical addresses.

14. The method of claim 11, wherein the graphical representation shows a path currently in use from an active source to an active sink differently than other paths in the graphical representation.

15. The method of claim 11, comprising, at the initial setup and/or when new devices are to join the system, automatically presenting the graphic representation.

16. TV comprising:
TV display;
TV processor controlling the display; and
computer readable memory accessible to the processor and bearing instructions executable by the processor to present a network map on the display, the map showing respective icons representing the TV and plural components connected thereto, the map also showing at least one selector element selectable to cause at least one address of at least one input port or at least one component or at least one input port and at least one component to be presented on the display, wherein responsive to a first selection of the selector element, HDMI physical addresses based on connected input ports are shown on the display, and wherein responsive to a second selection of the selector element, the HDMI physical addresses are removed from the display.

17. The TV of claim 16, wherein the icons bear labels indicating what type of component they respectively represent.

18. The TV of claim 16, wherein a currently active AV path is highlighted on the map relative to a currently inactive AV path on the map.

19. The TV of claim 16, wherein an icon representing a source of AV has a first shape and an icon representing a player of AV has a second shape, and the first shape is different from the second shape.

20. The TV of claim 16, wherein the selector element is a first selector element and the map includes a second selector element selectable to present an onscreen display (OSD) on the TV display giving a viewer an option to refresh the map, wherein the OSD gives a viewer an option to remove an icon from the map.
